(19) United States
(12) Patent Application Publication
(10) Pub. No.: US 2021/0241221 A1
(43) Pub. Date: Aug. 5, 2021

(54) PREDICTING GRAIN PRODUCTS LOADED ON-BOARD VESSELS

(71) Applicant: DA-Desk FZ-LLC, Dubai (AE)

(72) Inventors: Amit Rajendra Pathak, Dubai (AE); Bruno Jerzy Deszczynski, Dubai (AE)

(73) Assignee: DA-Desk FZ-LLC, Dubai (AE)

(21) Appl. No.: 17/164,518

(22) Filed: Feb. 1, 2021

Related U.S. Application Data
(60) Provisional application No. 62/970,590, filed on Feb. 5, 2020.

(51) Int. Cl. G06Q 10/08; G06Q 10/06; G06N 3/04; G06F 16/23; G01F 17/00

(52) U.S. Cl. CPC G06Q 10/0831; G06Q 10/06314; G01F 17/00; G06N 3/0427; G06F 16/23; G06Q 10/06315

(57) ABSTRACT

A predictive methodology for the grain and grain products market, including a robust predictor of grain-based cargo loading. The method may rely on data sources, AIS and machine learning to predict cargo operation. In some cases, grains and grain products are traded using a synonym. Synonyms have been accounted for in this method wherever available via an extensive commodity hierarchy taxonomy. The method provides benchmarking information on the basis of port calls, SOFs (statements of facts) and ullage reports to select the best berth for a grain commodity. The system and method provide for improved berth selection and facilitate quality improvements in cargo management systems. The method improves the currently available business intelligence related to cargo at berth and quality of information for shipping executives, managers, charterers and traders.

### PRIORITY

This application claims the priority of U.S. provisional patent application Ser. No. 62/970,590, filed on Feb. 5, 2020, which is incorporated in its entirety by reference herein.

### BACKGROUND

Navigating, transporting, managing, predicting and coordinating ocean vessel traffic is an age-old problem faced by the maritime industry for centuries. The maritime Automatic Information System (AIS) provides some information to address these problems. The Automatic Identification System (AIS) is an automatic tracking system used on ships and by vessel traffic services (VTS) for identifying and locating vessels by electronically exchanging data with other nearby ships, AIS base stations, and satellites. When satellites are used to detect AIS signatures, the term Satellite-AIS (S-AIS) is often used. AIS information supplements marine radar, which continues to be the primary method of collision avoidance for water transport.

Information provided by AIS equipment, such as, for example, but not limited to unique identification, position, course and speed, can be displayed on a screen or networked device. AIS is intended to assist a vessel's watchstanding officers and allow maritime authorities to track and monitor vessel movements. Conventionally, AIS integrates a standardized VHF (very high frequency) transceiver with a positioning system, such as a GPS (global positioning system) receiver, with other electronic navigation sensors, such as a gyrocompass or rate of turn indicator. Vessels fitted with AIS transceivers can be tracked by AIS base stations located along coast lines or, when out of range of terrestrial networks, through a growing number of satellites that are fitted with special AIS receivers which are capable of de-conflicting a large number of signatures. The base stations and satellites are coupled to networks for providing the AIS information to remote users.

The International Maritime Organization's International Convention for the Safety of Life at Sea requires AIS to be fitted aboard international voyaging ships with gross tonnage (GT) of 300 or more, and all passenger ships regardless of size. Accordingly, AIS is widely used in marine transportation systems.

While AIS information is becoming widely available, there is a need to extract meaningful data from this information for efficient operation of marine transportation systems. Moreover, there is a need to couple the AIS information with other transportation and port information to efficiently schedule and price transportation requirements. Additionally, loading and unloading times may be estimated fairly well; however, there may be wide variations in port operation times depending on terminal equipment, seasonality, port, berth and terminal utilization rates, as well as port operation characteristics and other conditions in the port area that affect the operation of those ports.

A challenge with complete reliance on AIS data is the “noise” in the ‘Destination’ and ‘Draft’ columns. Both these columns are updated by the crew and there is no regulation to mandate strict rules for updating these fields at the correct and designated intervals. Accordingly, supplemental information may be required to evaluate cargoes and transportation logistics, especially in the grain and grain products market.

The grain and grain products market is one of the most closely watched markets with very little open source information available. Many traders rely on information brokering houses for gathering data and leveraging this information for their trades. A detailed understanding of the shipping market can play a pivotal role in deciphering the rules of the grain market and the movement of grain shipments across the globe. Grains form an integral part of human diet and are one of the most commonly traded commodities via the sea as a transportation means. Different varieties of grains are cultivated in different parts of the world, and the need for a particular type does not usually match with the regions in need for those grains, thus creating a need to transport these grains to places which face a severe shortfall of this important food element. Grain trade has been prevalent since the ancient times. Grains, being extremely essential to diet and food preparation, is one of the most followed commodities in the shipping world. Understanding the trading patterns is of critical importance as it helps in maintaining a steady supply of grains to deficient countries. As grains are perishable, the transport of grains is difficult as compared to other dry commodities such as, for example, coal, ores, fertilizers and other fairly stable materials. Grains are a major component of the dry-bulk shipping sector and as such, their freight rates are closely watched and analyzed in the world marketplace. Even a slight change in the transportation costs drives the prices of grains higher and as such, most receivers (typically government entities with regards to large grain purchases) make sure that all risks are mitigated or minimized. Due to the inherent seasonality of grain crop production, grain markets are subject to tremendous seasonality pressure. Owing to all these factors, analysts and other stakeholders in the shipping industry prefer to have the latest information in hand or well in advance of a decision point so as to plan their strategies and minimize risk with respect to time, cost and quality of the transported grains to destination from source. The grain trade is risky owing to the fact that major exporting countries like the United States and Canada exercise very strict control over the approval of vessels carrying grain. These vessels must pass stringent requirements in order to be certified as fit for carrying the grain cargo. As the number of such certified vessels is limited, there is a great amount of price fluctuations with regards to the actual and projected freight rates, thereby increasing the overall grain market sensitivity.

In view of the foregoing, reliable quantification, estimation and scheduling is needed to maximize overall transport efficiency for ocean-going markets, including, but not limited to, the grain and grain products market. Accordingly, this present disclosure is directed towards an improved methodology utilized by an application tool which can help various stakeholders of the shipping and commodities industry to understand the trade flow of grains throughout the world. Inventive embodiments of the present disclosure employ a combination of technology for analysis, calculations, data storage and decision-making combined with domain expertise and the availability of historical data that can be inputted to the model and stored on an application tool for retrieval and continued updating with new data derived from the application tool. The shipping patterns evolving over time can be indications of the underlying grains supply-demand model, enabling predictive modelling and future trend analysis, correlation and predictive analytics using the embodiments of the inventive methods and application tools as disclosed herein.

In one embodiment of the present invention is a method for cargo volume analysis to optimize grain transport involving the steps of: (a) receiving AIS information at a network server, the network server coupled to a network and a database wherein the MS information includes at least a vessel draft information and a location information; (b) calculating a Tonnes Per Centimeter Immersion (TPCI) value in response to the vessel draft information; (c) determining the cargo type from the location information using predictive analytics; (d) confirming the carriage capability for a grain or grain product using the predictive analytics; (e) determining the cargo volume available for the grain or grain product from the predictive analytics; and then (f) updating the database by classifying identified vessels suitable for grain carriage.

In a related embodiment of the present invention, the predictive analytics includes applying association rules to an historical dataset to identify at least one or a plurality of vessels available for grain carriage having either a draught loading capacity or draught discharging capacity greater than or equal to the volume of the grain or grain product to be transported. In yet another related embodiment, the association rules include information about available shipping ports having terminals with grain handling capability and identifying at least one berth with the capacity for performing a shipment operation selected from a loading operation, discharging operation, another operation, or combination of the operations; wherein the berth meets at least one of the threshold draught loading capacity or draught discharging capacity.

In another embodiment of the present invention, the method employing predictive analytics includes using Lineup and Berthing Schedules to determine the most efficient combination of schedules for performing at least one or a plurality of the shipment operations between at least one ship and at least one suitable berth identified from the historical dataset; wherein the suitable berth has the capability and capacity of handling a shipment operation involving the grain or grain product. Further, the predictive analytics determines the most efficient schedule for a specific vessel and port listed in the database and allocates a specific terminal and port to receive the vessel in response to the vessel speed and updates the database with a future terminal prediction to schedule the shipment operation.

In one embodiment of the present invention, the method of using predictive analytics includes using an artificial neural network in response to an historical dataset stored on the database.

In yet another related embodiment of the present invention is a method for analyzing maritime cargo information involving the steps of: (a) receiving AIS information at a network server; the network server coupled to a network and a database; and wherein the AIS information includes at least a vessel draft information and a location information; (b) processing the AIS information to remove outliers, incomplete information, and to standardize the information format; (c) effectuating association rules in response to the processing; (d) applying the association rules in response to a query received at the network server; and (e) responding to the query with the results; wherein the results include a list of ships with grain or grain product cargo space that lie within a projected spacial polygon of available ports with terminals having the capacity and capability of handling a shipment operation involving the grain or grain product.

In a related embodiment of the present invention, is the use of one or more processor-readable storage devices, such devices including non-transitory processor instructions directing a processor to perform a method involving the steps of: (a) receiving AIS information wherein the AIS information includes at least a vessel draft information and a location information; (b) calculating a TPCI in response to the vessel draft information; (c) determining cargo type from the location information using predictive analytics; (d) confirming a grain or grain product using predictive analytics; (e) determining the cargo volume available for the grain or grain product from the predictive analytics; (0 confirming carriage capability for a grain or grain product using predictive analytics; (g) determining the cargo volume available for the grain or grain product from the predictive analytics; and (h) then updating the network by classifying vessels suitable for grain carriage in the database.

In a related embodiment of the present invention, the predictive analytics determines the most efficient schedule for a specific vessel and port listed in the database and allocates a specific terminal and port to receive the vessel in response to the vessel speed and updates the database with a future terminal prediction to schedule the shipment operation, and further the historic cargo information is updated on the database to include the future terminal prediction and schedule information for the specific vessel and port allocated for the shipment operation.

In yet another related embodiment of the present invention, the results of the predictive analytics are applied to update the database after the shipment operation has been completed with at least one or a plurality of operations parameters associated with the shipment operation, so that the updated database information can then be used to enable determination and scheduling of a second shipment operation for the specific vessel at a second destination port, terminal and berth, for a subsequent shipment operation.

### SUMMARY

Disclosed herein are methods and application tools that enable an accurate predictive methodology related to grain and grain products that are transported by vessels around the world. Disclosed herein is a system and method for determining operating characteristics of a maritime vessel by receiving AIS information, including vessel draft information, analyzing vessel location information, including the history of vessel positions at loading and discharging stations; analyzing cargo records including grain and grain products; and analyzing that information to determine key grain market information to facilitate more efficient handling of grain and grain products. Certain embodiments provide for calculations of a vessel characteristic Tonnes Per Centimeter Immersion (TPCI) which may be associated with certain types of cargoes. Moreover, artificial intelligence using tools such as neural networks, other prediction methodologies and related predictive analytics may be employed to estimate key missing data. The system and method provide for improved vessel performance metrics and facilitate quality improvements in grain- and grain product-based cargo management systems.

Vessel draft information may be supplied either in port or underway and corrective calculations may be employed to associate the changes in cargo to the type of cargo by analyzing the vessel's historic cargo and historic locations. These historic locations may be identified with known cargo load and discharge stations (for example, grain stations or grain product terminals) to determine the type and amount of cargo loaded or discharged. In addition, historical or newly added information may be quantified using artificial neural network (ANN) methodologies.

In the present disclosure, computer-based data mining algorithms have been used to fill gaps in the data. With current information gathering practices relying heavily on information houses with little to moderate coverage, these computer-driven algorithms are well-positioned to cover the entire globe. Apart from allowing global coverage, the described system is cost-effective and easily scalable.

The cargo data may include not only information about many distinct types of grains and grain products, but may also dive deep into their characteristics such as API gravity, angle of repose, packing efficacy and settling characteristics that affect ultimate weight and volume shipment data, as well as storage and handling characteristic required by the particular grain or grain products, as these are typically perishable materials that have a finite lifetime, and thus storage temperature, humidity, packing volume, and time of storage and transport are additional data that can optionally also be tracked and stored in a database or data storage device(s). This information is gathered primarily from a commercially available anonymized database which provides an accurate summary of the loaded/discharged cargo and from the port documentation gathered over time from port authorities. The cargo database may also include comprehensive information about the synonyms, abbreviations and trade names of the grains and grain products.

The collective grains data may also include information related to historical and upcoming fixtures. The fixtures data is gathered primarily from brokers, and public information. This authentic data is supplemented by additional data from other information houses. The historic fixtures play a key role in understanding the charterer and shipper for each grain type or grain product shipment. These historic trends provide for better predictive and analytical modelling of the dataset.

With the advent of the AIS, tracking ships has become relatively easier. However, given the understanding that AIS data is not completely reliable, the embodiments herein include other data sources for the data modelling. For example, the statement of facts and ullage (available headspace within a container or transport vessel) reports provide a clear indication of the cargo carried in certain cases. This information can be used effectively to populate missing data points by using machine learning algorithms. These algorithms may be either unsupervised as well as supervised, or both.

### BRIEF DESCRIPTION OF THE DRAWINGS

FIG. 1 shows a flow-chart of the first steps in a process acquiring and qualifying suitable carrier vessels.

FIG. 2 shows a flow-chart of a process to analyze AIS information to determine vessels bearing a suitable navigation status.

FIG. 3 shows a flow-chart of a process to rule out vessels and classify only those suitable for grain carriage.

FIG. 4 shows a flow-chart of a process to employ vessel information, loading capacity and threshold values to determine if a loading or discharging or other operation is warranted.

FIG. 5 shows a flow-chart of a process using AIS and Lineup database information to locate potential ports and terminals within a polygon region (spacial zone) suitable for vessels.

FIG. 6 shows a flow-chart of a process to determine the status of a vessel as suitable for grain carriage and to update the vessels AIS and Lineup database with key parameters that uniquely identify the vessel.

FIG. 7 shows a flow-chart of a process to review vessel suitability based on Lineup and berthing schedules to allocate a specific terminal or berth within a terminal.

FIG. 8 shows a flow-chart of a process to either allocate a terminal based on current information found in Lineup database, or to predict, either from retrospective data or future predictive modeling, a suitable terminal and then allocate that terminal.

FIG. 9 shows a functional block diagram of a client server system.

### DESCRIPTION

Generality of Invention

This application should be read in the most general possible form. This includes, without limitation, the following:

References to specific techniques include alternative and more general techniques, especially when discussing aspects of the invention, or how the invention might be made or used.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

References to “preferred” techniques generally mean that the inventors contemplate using those techniques, and think they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Lexicography

The term “grain” and “grain product,” either in singular or plural form, generally refers to types of grains and seeds including but not limited to, wheat, wheat berries, hominy, spelt, rye, brown rice, farro, emmer, barley, bran, durum wheat, triticale, bulgur wheat, couscous, farina, kamut, orzo, semolina, triticale, graham, oats, corn, maize, cornflour, cornmeal, rice, wild rice, teff, montina flour, sorghum, oats, freekeh, emmer, eikorn, a tta flour, amaranth, quinoa, millet (finger, foxtail, Japanese kodo, pearl, adlay, and proso), barley malt, bleached flour, kasha, cereals, wheat germ, millet, granary flour, groats (wheat, barley, buckwheat), pastas, matzo, rice milk, seitan, tabbouleh, udon (wheat noodles), corn starch and wheat nuts, and grain products such as malts (made from wheat), graham (made from wheat), couscous (made from wheat seminola), polenta (made from corn), muesli (made from oats or wheat), seitan (made from wheat), panko (made from wheat), and the like. examples of suitable seeds include, but are not limited to, pulses or grain legumes, members of the pea family including chickpeas, common beans, garden peas, fava beans, lentils, lima beans, lupins, mung beans, peanuts, pigeon peas, runner beans, soybeans and oilseeds, and further including the mustard family seeds like rapeseed, black mustard, India mustard, canola, and aster family seeds like sunflower, safflower, flax, hemp and poppy seeds.

The term “Association Rules” generally refers to rules, such as if-then-else statements, that help to show the probability of relationships between data items within large data sets in various types of databases. Association rule mining, at a basic level, may involve the use of machine learning models to analyze data for patterns, or co-occurrence, in a database (data storage devices(s)) and identify frequent if-then associations, which may be applied as rules.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “fixture” generally refers to the conclusion of charter negotiations between owner and charterer when an agreement has been reached to charter a vessel. A fixture generally refers to a “fixed” vessel, which means there is a fully fixed recap with the chartering conditions removed.

An International Maritime Organization (IMO) number is a unique reference for ships, registered shipowners and management companies.

The term “recap” generally refers to the document transmitted when a fixture has been agreed, setting forth all of the negotiated terms and details so far. It is shorthand for “recapitulation of agreed terms” between a ship owner and a charterer. This is the operative document until the charter party is drawn up.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value but might be with respect to a measure or value held by that measurement or value at another place or time.

The terms “structured data” and “structured data source” generally mean a coherent way to save and access information such as in a database, XML file and the like, on a data storage device.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description”, “this disclosure” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a single computer even though it is part of a separate computer or may be virtualized using resources from multiple computers.

The term “ANN” or “artificial neural network” refers to methodologies that employ advanced neural network architectures and systems to analyze and model complex parameter sets and to provide predictive modeling results in response to historical data and responses, and includes both commercial and proprietary computer systems and programs hosting the network algorithms, also referred to as “artificial intelligence” or “AI” systems.

The term “MARCURA” refers to “The Marcura Group”, a Dubai-based group of companies providing specialized services to the global maritime industry.

The term “DA-DESK” refers to a MARCURA subsidiary which is the largest port cost management service provider in the global maritime industry.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

System Elements

Client-Server Processing

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remotely connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices, thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), AIS transmitters and receivers, laptop, notebook and tablet computing devices operating through wireless (WiFi) networks. These wireless devices may include a processor, memory coupled to the processor, displays, keypads, WiFi, Bluetooth, GPS and other I/O functionality. Alternatively, the entire processing system may be self-contained on a single device or effectuated remotely as a virtual machine.

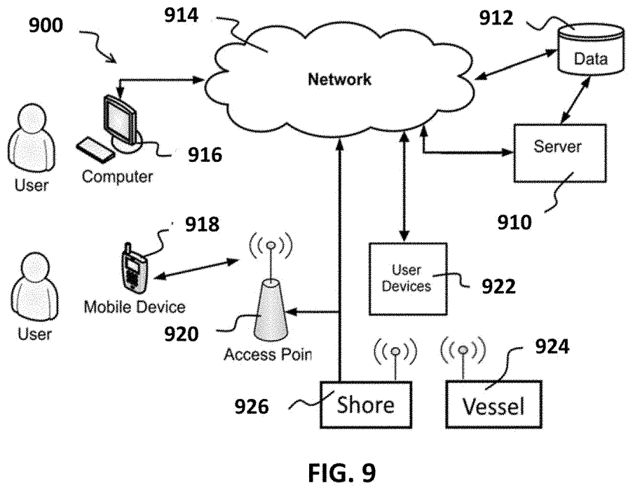

Embodiments of the client-server processing system, including architecture, databases, devices, network and related devices that support the system are disclosed and detailed hereinbelow in the discussion accompanying FIG. 9.

AIS Data

An AIS transceiver sends the following data every 2 to 10 seconds depending on a vessel's speed while underway, and every 3 minutes while a vessel is at anchor:
(1) The vessel's Maritime Mobile Service Identity (MMSI), a unique nine-digit identification number;
(2) Navigation status, such as “at anchor”, “under way using engine(s)”, “not under command”, etc.;
(3) Rate of turn: right or left, from 0 to 720 degrees per minute;
(4) Speed over ground: 0.1-knot (0.19 km/h) resolution from 0 to 102 knots (189 km/h);
(5) Positional accuracy: longitude—to 0.0001 minutes, latitude—to 0.0001 minutes;
(6) Course over ground: relative to true north to 0.1°;
(7) True heading: 0 to 359 degrees (conventionally from a gyrocompass);
(8) True bearing at own position: 0 to 359 degrees;
(9) UTC (Coordinated Universal Time) seconds: The seconds field of the UTC time when these data were generated. A complete timestamp is conventionally not transmitted.

In addition, the following data is broadcast every 6 minutes:
(1) IMO ship identification number, a seven-digit number that remains unchanged upon transfer of the ship's registration to another country;
(2) Radio call sign: an international radio call sign, up to seven characters, assigned to the vessel by its country of registry;
(3) Name of vessel, up to 20 characters;
(4) Type of ship/cargo;
(5) Dimensions of ship, to the nearest meter;
(6) Location of positioning system's (e.g., GPS) antenna on board the vessel, in meters aft of bow and meters port of starboard;
(7) Type of positioning system, such as GPS, DGPS (differential GPS) or LORAN-C (long range navigation mode C);
(8) Draft of ship: 0.1 meters to 25.5 meters;
(9) Destination, up to 20 characters;
(10) ETA (estimated time of arrival) at destination: UTC month/date hour and minute; and
(11) Optionally, high precision time request. A vessel can request other vessels provide a high precision UTC time and date-stamp.

In addition to AIS data, proprietary data may also be included in certain embodiments. In addition to traditional analysis tools involving modeling and projection calculations and prediction, embodiments of the present invention can also employ proprietary AI systems to analyze and update AIS information, including the use of predictive analytics. For example, and without limitation, ANN or connectionist systems are computing systems vaguely inspired by the biological neural networks that constitute animal brains. The neural network itself is not an algorithm, but rather a framework for many different machine learning algorithms to work together and process complex data inputs. Such systems “learn” to perform tasks by considering examples, generally without being programmed with any task-specific rules. For example, in image recognition, they might learn to identify images that contain cats by analyzing example images that have been manually labeled as “cat” or “no cat” and using the results to identify cats in other images. They do this without any prior knowledge about cats, for example, that they have fur, tails, whiskers and cat-like faces. Instead, they automatically generate identifying characteristics from the learning material that they process. Similarly, port call and vessel loading information may be used to “teach” ANN about grain and grain product shipping.

An ANN is based on a collection of connected units or nodes called artificial neurons, which loosely model the neurons in a biological brain. Each connection, like the synapses in a biological brain, can transmit a signal from one artificial neuron to another. An artificial neuron that receives a signal can process it and then signal additional artificial neurons connected to it.

In a conventional AIS installation, most of the data fields are updated automatically by querying ship's sensors. However, destination and draft data are often entered manually by the vessel crew. Data entry by hand is prone to errors, and it can be updated with a time delay from when the draft or destination changes. Since it is manually entered, it is not always updated until the vessel is finished loading or unloading cargo. For example, the ship's crew updates AIS data field “draft of ship” immediately after completion of cargo operations and while the ship is still at the berth, or often the ship's crew updates AIS draft data field (with a delay) while the ship is no longer at the berth and/or is no longer within the port limits.

A vessel's draft is indicative of its loading and a change in draft, except for minor variations, indicates a change in the vessel's loading status. Draft of a ship may change by 0.1 to 15 meters depending on the cargo. The Table 1 below shows AIS draft data for a vessel.

TABLE 1

| Row | | Draft | |
|---|---|---|---|
| Number | Timestamp | value (meters) | |
| 01 | 05/01/2018 00:00 | 6.3 | m |
| 02 | 05/01/2018 01:00 | 6.3 | m |
| 03 | 05/01/2018 02:00 | 6.3 | m |
| 04 | 05/01/2018 03:00 | 6.3 | m |
| 06 | 05/01/2018 04:00 | 6.3 | m |
| 07 | 05/01/2018 06:00 | 10.3 | m |
| 08 | 05/01/2018 07:00 | 10.3 | m |
| 09 | 05/01/2018 08:00 | 10.3 | m |
| 10 | 05/01/2018 09:00 | 10.3 | m |
| . . . | . . . | . . . | |
| 40 | 05/03/2018 04:00 | 10.3 | m |
| 41 | 05/03/2018 05:00 | 7.5 | m |
| 42 | 05/03/2018 06:00 | 10.3 | m |
| 43 | 05/03/2018 07:00 | 10.3 | m |
| 44 | 05/03/2018 08:00 | 10.3 | m |

As per the above table, at rows 06-07, draft value changed from 6.3 to 10.3 meters, which is by 4.00 meters. Here, a recording system may record a “Loading” operation with the Timestamp of 05/01/2018 06:00.

At rows 40, 41 and 42, draft value changed from 10.3 to 7.5 meters and then back to 10.3 meters. In this case, row 41 may be considered as an outlier and omitted from any analysis, because the change of draft value happened during a very short timeframe (within 2 hours). Generally, such outliers can be related to errors in AIS data transmission and may be accordingly ignored.

Average Draft Variation

The amount of draft change transmitted by AIS is generally a function of the great variety of vessel sizes. Merchant cargo vessel displacement varies from 10,000 deadweight tons (DWT) to 450,000 DWT and vessel length reaches 400 meters. This makes uniformity generalization subject to large errors.

However, the applicants, by analyzing a representative subset of global vessel fleet and its historical AIS Draft data, determined that draft value variance is proportional to the vessel size. Table 2 below details observed draft minimums and maximums for different vessel sizes, as well as observed draft standard deviation (STDEV), which expresses by how much the draft value observations differ from the mean value.

TABLE 2

| | | | Observed |
|---|---|---|---|
| | Observed | Observed | standard |
| DWT | min. draft | max. draft | deviation |
| 400000 | 8 | 23.5 | 4.97 |
| 300000 | 8 | 23.5 | 4.30 |
| 200000 | 8 | 19 | 4.05 |
| 131000 | 7 | 16 | 1.94 |
| 51000 | 5 | 12.5 | 1.94 |
| 17000 | 4 | 8 | 0.77 |

The STDEV value per vessel may be used as the threshold for draft value change. Table 2 above presents representative examples of draft (draught) changes in response to vessel DWT (dead weight in units of tonnes), showing typical observed values and deviations. Hence, to record a vessel operation, the draft value change would need to exceed the threshold determined by the STDEV. For example, a 400,000 DWT vessel draft has changed from 20.5 to 20.0 meters (0.5 meters). Since this amount is less than the 4.97 meters threshold for the vessel, the draft change would not be recorded. This relatively insignificant draft value change of 0.5 meters may be a result of vessel de-ballasting or other reasons not related to vessel cargo operations, whereas a draft change of 6 meters would indicate a change of cargo.

Tonnes Per Centimeter Immersion (TCPI)

Additionally, it is possible to estimate the amount (metric tons) of cargo loaded or discharged. This can be accomplished by using the vessel characteristic TPCI, which expresses the number of tonnes required to alter the draft of a vessel by one centimeter. The TPCI varies with the draft and with the water density. Changes in draft cause a change in displacement and the TPCI assists in calculating the change. TPCI can be calculated by the formula:

TPCI=(A)×(d)/100 Eq. 1
where A=area of water plane at a certain draft and d=density of water in which the ship floats.

Knowing the change in draft provides for a calculation of the change in tonnage being carried by the vessel.

Extracting Information from Lineups

Along with commercial information suppliers, information may be procured from global vessel lineups confirmed by local agents. These lineups provide critical information related to the vessel, cargo, charterer and shipper. The lineups are procured in many formats from agents and information houses from around the world. The lineups are processed and fed into a continuously updating lineups database algorithmically. The algorithms transform the lineups from various formats into one standardized format. The standardized format contains information to effectively understand the future route of a vessel by populating the ‘PREVIOUS_PORT’ and ‘PORT_LINEUP’ fields in the database. In some cases, the lineups provided by agents also make the prospective terminal and berth information available. The following are representative fields and their classification:

| CATEGORY | FIELDS |
|---|---|
| REPORT | REPORT_DATE, REPORT_PROVIDER |
| VESSEL | VESSEL_IMO, VESSEL_DWT, VESSEL_TYPE |
| PORT | PORT_LINEUP, TERMINAL_LINEUP, |
| | BERTH_LINEUP |
| CARGO | CARGO_LINEUP, CARGO_TYPE_LINEUP, |
| | CARGO_QUANTITY, UNITS |
| OPERATIONS | ETA, POB, ETB, ETD, ATA, ATD, ATD, |
| | DELAY_DAYS |
| BUSINESS | SHIPPER, RECEIVER, CHARTERER |

Attention is drawn to the REPORT_DATE, REPORT_PROVIDER fields which allow insights into the agency by which the report is provided and on which the data has been transformed by the proprietary algorithms. The VESSEL fields provide all the required information to accurately identify the vessel and then relate the vessel structural and operational characteristics of the vessel for further processing in the data models for predicting the cargo operations.

The PORT fields contain information related to the port/terminal or berth at which the port call will occur. In some cases, terminals and berths are provided by agents. Algorithms employing spatial functions are used to populate these fields for cases with missing data points. An additional dataset which categorizes terminals/berths as wet or dry may aid an algorithm to optimize its search and populate the missing data in the terminal/berth fields.

The CARGO fields provide all critical insights into the cargo that will be loaded on the vessels along with the sub-type of the cargo. For grains and grain products, the sub-type is the grain product or blend of grains, including those grains capable of being combined or blended for transport. For example, the product “Wheat Cereal” (a mixture of grains representing a grain product) will be specified when the vessel is slated to be in Jebel Dhana or in Fujairah. The CARGO_QUANTITY denoted the quantity to be shipped and the UNITS field specifies the units of measurement used for the transaction.

The OPERATIONS fields are critical in cases where limited information is available, and some information needs to be derived. These fields are populated based on a combination of statement of facts (SOF) and AIS data. The SOFs provide a strictly chronological sequence of events and thus aid in understanding the vessel operations to the core. The timestamps on these events may provide valuable information in deciphering the shipping patterns alongside confirming other fields in the dataset.

The BUSINESS fields are important identifiers for developing association rules, clustering paradigms and other advanced data models like neural networks which help in significantly improving the quality of the data. Hidden and obvious patterns can be unearthed using these algorithms to impute missing data points.

Extracting Information from Berthing Schedules & Plans

Apart from lineups information from the berthing plans, berthing schedules or daily ship loading plans may be employed in certain embodiments. These plans or schedules are an effective way of corroborating the lineup data received from the agents. These plans confirm the berthing of ships in a particular port at a particular berth.

From the berthing plan or schedule, information is corroborated and updated into the lineups database as describe herein. The berthing plans provide detailed information with regards to ‘time alongside’. The ‘time alongside’ duration may be one of the important factors for determining the cargo and the vessel. The ‘time alongside’ concept explains the size of the vessel in tandem with other parameters like ‘load rate’ and ‘time slot operation’ from other supporting databases. The recurring activity for a particular type of vessels helps in assigning the berth and, by association, the terminal to a particular type of cargo.

Extracting Information from Fixtures

This data indicates if a ship has been fixed for employment or not. The most beneficial part of the fixtures data is that the fixtures can be acquired well in advance, thus allowing ample time for accurate research before finalizing a particular cargo loading/unloading. The fixtures data may be used to fill up the gaps in the above sources, namely, lineups and berthing plans. This database contains a field named ‘fulfilled’ which may be a logical operator with values ‘1 or ‘0. This field is useful while optimizing search and focusing only on the fulfilled fixtures. The following are representative fields from the FIXTURES database along with their classification:

| CATEGORY | FIELDS |
|---|---|
| REPORT | REPORT_DATE, REPORT_PROVIDER |
| VESSEL | VESSEL_IMO, VESSEL_DWT, |
| PORT | PORT_LINEUP, TERMINAL_LINEUP, |
| | BERTH_LINEUP |
| CARGO | CARGO_LINEUP, CARGO_TYPE_LINEUP, |
| | CARGO_QUANTITY, UNITS |
| OPERATIONS | LAYCAN FROM, LAYCAN TO |
| BUSINESS | SHIPPER, RECEIVER, CHARTERER |

The OPERATIONS category contains the ‘LAYCAN FROM’ and ‘LAYCAN TO’ fields which provide information about the LAYCAN duration. LAYCAN or Laydays Canceling is defined as the period during which the shipowner must tender notice of readiness to the charterer that the ship has arrived at the port of loading and is ready to load. This period is expressed as two dates. These fields also provide a clear indication of the vessel's estimated ETA. Along with this, the fixtures data provides valuable information that is used to confirm the data generated from AIS and other sources.

Vessel Location

In some embodiments, when a vessel cargo operation is recorded, a location may be assigned to the vessel cargo operation. The location may be a load/discharge station such as a port, terminal, off-shore transshipment zone, transfer zone, lightering zone, anchorage or other similar marine facility. Some embodiments may assign the nearest load/discharge station to the cargo operation in response to the current vessel position. In alternative embodiments, the vessel's historical positions may be queried from a structured data store together with known load/discharge stations. These location databases may contain pre-defined geofences of these marine locations. Once queried, the valid load/discharge station may be recorded with the cargo operation information.

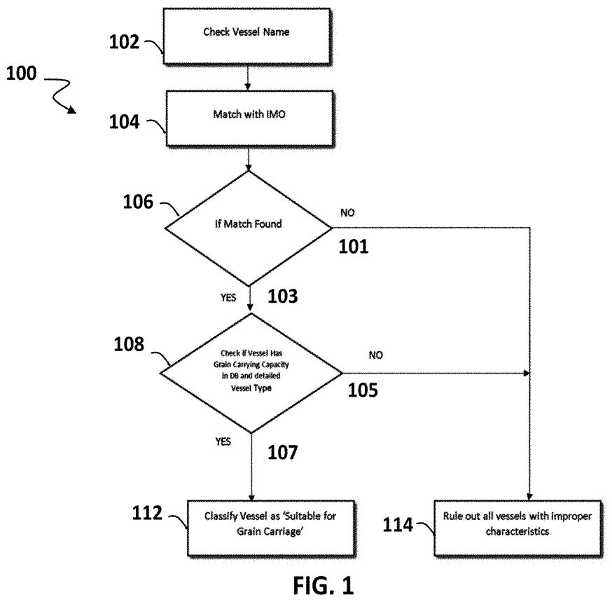

FIG. 1 shows a flow-chart of one embodiment of the present disclosure that describes the first and foremost step required to analyze and cleanse the required data in order to acquire and qualify suitable grain carrier vessels. As mentioned above, vessels carrying grains are highly regulated and it is thus very important to cater to this need and identify accurately vessels which can or cannot carry grain. MARCURA gathers data by scraping data off lineups, vessel schedules and information published by port authorities or shipping agencies. Information received is in various forms and the templates adopted by each independent agency vary greatly. For example, some lineups mention the vessel's name instead of the IMO number. This makes it highly impossible to accurately pinpoint the vessel and include it in the cleansed version of the dataset for further processing. The simple algorithm first determines if the vessel can carry grains at all and then assigns an IMO based on:
(1) Vessel specific information stored in the database;
(2) Shipping logic; and
(3) Historical data from DA-DESK.

The vessel-specific information stored in the database includes data fields which specify the grain carrying capacity of the vessel. If a non-NULL value has been recorded in the data field, the vessel can be said to have grain carrying capacity.

The shipping logic plays a crucial role in classifying the grain vessels. For example, in case the Vessel Name matches multiple IMOs, a classification exercise needs to be carried to accurately identify the vessel which actually carried the grain cargo. Generally, grain cargoes are transported by smaller vessels and not by Capes (Capesize bulk carriers) or VLBCs (Very Large Bulk Carriers). This, in itself, can prove to be a classification method. Further, in inventive embodiments of the present disclosure, vessels are analyzed based on other parameters like type of cargo carried in the past. This is the next stage of verification. In this stage, a vessel is analyzed for the cargoes it has carried in the past. This is in response to the DA-DESK data and thus vessels carrying wet cargoes like oil, CPP (crude petroleum products) and the like can be ruled out immediately. Also, information points such as number of cargo pumps, for example, becomes valuable information while segregating and classifying vessels of interest.

FIG. 1 illustrates steps in a method (100) that may be employed in certain embodiments. The method begins at a flow label 100 with an inquiry to the AIS database (DB) to determine the vessel name. At a step 102 a system, such as a processor or server, receives MS information concerning the vessel name. This reception may be from a network such as the Internet, and serves to identify the vessel name. At step 104, a search is conducted to with IMO to determine if a match is found (106). If no match is found (101), then the system rules out all vessels with improper characteristics from further evaluation. If a match is found (103), the system then checks the DB whether the vessel has grain carrying capacity and details of the vessel type. If it is determined that the vessel is not suitable (105), then this particular vessel is ruled out as having improper characteristics and is removed from further evaluation (114), the DB being updated accordingly with respect to each vessel. However, if the vessel grain carrying capacity of the vessel is determined to be sufficient (107), then that particular vessel and others in an iterative loop of this initial screening method 100 are then the vessels so identified are classified as “Suitable for Grain Carriage” (112). This information is stored in the DB for subsequent use.

Location Vetting and Cargo Prediction

The methods and applications of embodiments of the present disclosure presented herein accommodate and rely on location vetting to ensure that the identified vessels are carrying a specific grain type (e.g., grains: wheat, corn, barley, rice, oats, sorghum; and further sub-groups for wheat: hard red winter, soft red winter, hard red spring, durum and the like). It relies on various parameters from the geographic, maritime, ports, terminals, berths and floating transportation and offloading vessel domains to build a cargo prediction system with significant levels of accuracy. One example would be Mississippi river locations as shown in Table 3.

TABLE 3

| | Location | | | | | | | | | | |
|---|---|---|---|---|---|---|---|---|---|---|---|
| Charterer | Name | January | February | March | April | May | June | July | August | September | Totals |
| ADM | Ama | 16 | 12 | 15 | 15 | 16 | 10 | 13 | 17 | 14 | 128 |
| ADM | Destrehan | 17 | 15 | 16 | 17 | 17 | 14 | 15 | 17 | 8 | 136 |
| ADM | Reserve | 9 | 11 | 9 | 8 | 5 | 0 | 0 | 0 | 0 | 42 |
| ADM | St. Elmo | 0 | 0 | 0 | 0 | 0 | 0 | 0 | 0 | 0 | 0 |
| Bunge | Destrehan | 10 | 9 | 13 | 10 | 10 | 7 | 9 | 12 | 13 | 93 |
| Cargill | Reserve | 18 | 14 | 17 | 21 | 12 | 4 | 17 | 15 | 13 | 131 |
| Cargill | Westwego | 16 | 13 | 14 | 11 | 14 | 14 | 12 | 15 | 13 | 122 |
| CHS | Myrtle Grove | 13 | 8 | 11 | 13 | 9 | 6 | 7 | 11 | 6 | 84 |
| Louis | Baton Rouge | 7 | 8 | 5 | 5 | 4 | 2 | 3 | 7 | 7 | 48 |
| Dreyfus | | | | | | | | | | | |
| MGMT | Buoys | 9 | 6 | 6 | 8 | 4 | 4 | 5 | 5 | 4 | 51 |
| Zen-Noh | Convent | 23 | 19 | 17 | 16 | 16 | 19 | 16 | 22 | 24 | 172 |
| Totals | | 138 | 115 | 123 | 124 | 107 | 80 | 97 | 121 | 102 | 1007 |

Table 3 presents the count of vessels that are performing activities in the mentioned locations allowing to assign a cargo of the wheat type of hard red winter. Also, the schedule of sowing and harvesting is used to assure proper type of cargo is assigned. Location is mainly used to further reassure that the vessel classified as Grain Carrier is performing actions related to grains via identification of grain elevators around the world in a dynamic fashion. Those locations and polygons, or points would be classified as “grains-related locations”.

DA-DESK's and MARCURA's Ports Document Management System (PDMS) databases gather information by scrapping records of the Bills of Lading (BoLs), SOFs and port call databases, which store information of cargo grade, locations, vessels, and related data. The SOF logs events and allied changes in location and draft of a vessel. This information is used to generate an accurate understanding of loading-discharging activities and the quantity of cargo loaded or discharged and the type of the cargo. The SOF events include headers like End of Sea Passage (EOSP), All Fast, Pilot on Board (POB), Last Line and Commencement of Sea Passage (COSP). Draft changes recorded for these events are an accurate indicator of loading/discharging activity and quantity of cargo.

AIS Based Verification

In some cases, it may be really difficult to pinpoint vessels accurately owing to the fact that they have common names and they operate in extremely remote ports. Here, AIS data and proprietary polygons created by MARCURA play a critical role and ensure 100% validation. The algorithm is as follows:

The AIS (location-based) method is the most reliable and follows a set path of classification and IMO assignment.

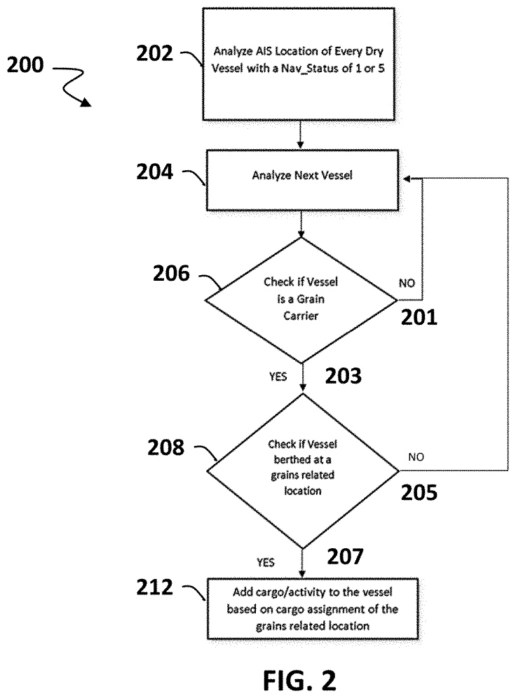

FIG. 2 illustrates steps in a method (200) that may be employed in certain embodiments. The method begins at a flow label 202 with an inquiry to the AIS database (DB) to determine the location of every “Dry” (empty or storage transport capable) vessel with a Navigation Status (Nav_Status) of either 1 or 5. In subsequent steps, each vessel is analyzed for its particular characteristics in step 204 and a determination made at step 206 whether the vessel is a suitable grain carrier. If not (201), another vessel is analyzed at step 204 until at least one qualified vessel suitable as a grain carrier is identified (203) and then a determination (208) is made as to whether that particular vessel is berthed at a grains related location in real time (at present). If the vessel is found to be presently berthed (207), then the grain cargo/activity is added to the DB to establish a cargo assignment for that vessel in order to reserve the necessary cargo storage while further determinations are conducted in subsequent steps described below. If, however, that particular vessel is not presently berthed at a grains-related location (205), the information is stored that it is a potentially suitable vessel for future selection but the search for an appropriately berthed vessel meeting the requirements is continued at step 204 with the analysis of additional vessels found in the DB.

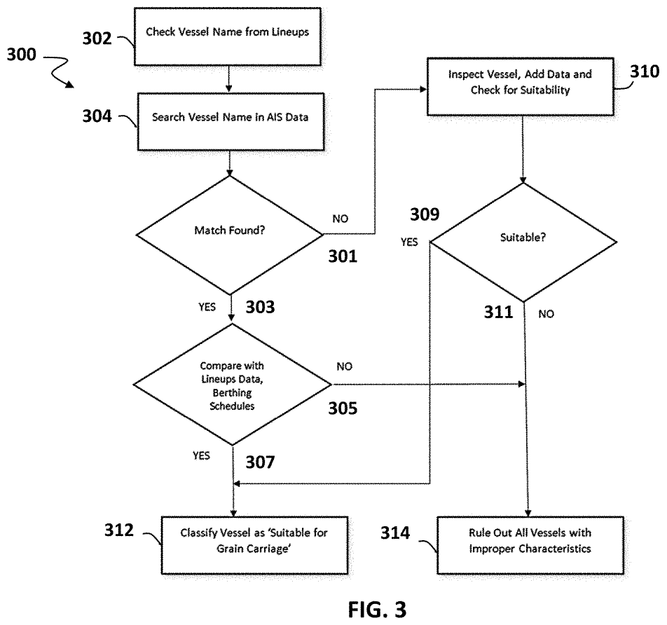

Once a list of suitable vessels is found, additional evaluation is conducted as shown schematically in FIG. 3, which illustrates steps in a method (300) that may be employed in certain embodiments to classify a vessel as suitable for grain carriage. In a first step 302, the DB is queried to find the Vessel name from Lineups (a database derived listing of vessels) and then the vessel name is searched in the AIS Data to determine if the vessel is identifiable as being commonly listed in both databases in step 304. If no match is found (301), information about the vessel is inspected and a determination made at step 310 as to vessel suitability. If found suitable (309), the vessel is then classified in step 312 as “Suitable for Grain Carriage” (312) and the DB and lineups information updated appropriately. If, however, found not suitable (311), the vessel is ruled out as having improper characteristics (314) and the DB updated accordingly to remove this vessel from current consideration. If, however, at step 304 a match is found between the lineups and AIS data (303), then information is compared and data regarding lineups parameters, berthing schedules and related information is extracted to determine vessel suitability. If not suitable (305), the system rejects the vessel and adds the vessel to the list of those with improper characteristics at step 314. If, however, the comparison of Lineup data and berthing schedules identifies a suitable vessel (307), then this particular vessel is then classified as “Suitable for Grain Carriage” (312).

Flows Generation Including Cargo Assignment

Embodiments of the present disclosure enable methods and systems to assign grain cargoes to the vessels found suitable. In one embodiment, the system takes into consideration lineups acquired from the agents usually include only the port where the vessel is expected. Along with the port, the lineups usually contain the following data fields:
(1) Berth at which vessel is expected (this information is published by the port and the information is collated by agents);
(2) Terminal, if listed;
(3) Charterer;
(4) Estimated Time of Arrival;
(5) Estimated Time of Berthing;
(6) Estimated Time of Departure;
(7) Cargo;
(8) Quantity; and
(9) Shipper-Receiver.

However, it becomes absolutely necessary to know the activity for which the vessel is expected at the port. The following process is one example that illustrates a means for determining and assigning the activity of the vessel.

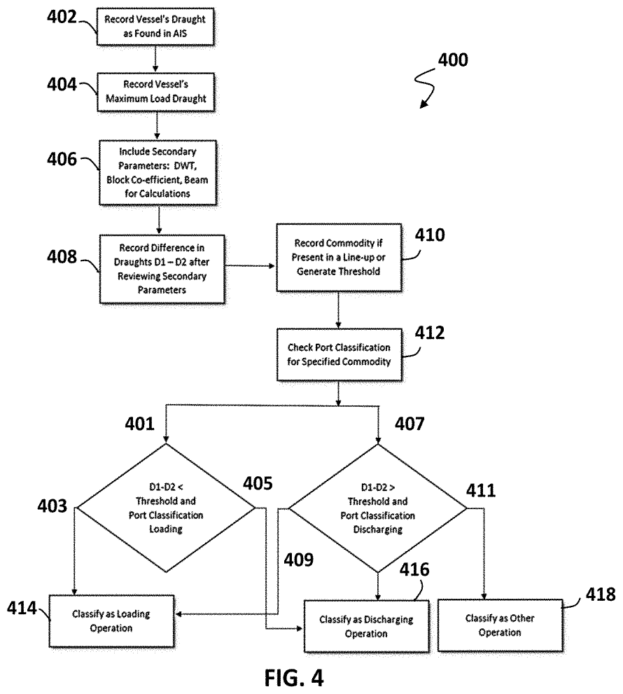

One embodiment of the process (400) as shown in FIG. 4 starts with identifying the vessel and its IMO from the prior determination of suitable vessels found and updated to the lineups list in the DB. The vessel's current draft can be recorded from the MS at step 402, and the vessel's maximum load draft recorded at step 404. In addition, at step 406, secondary parameters including DWT, block coefficient and Beam parameters are retrieved from the DB in order to enable calculation and recordation at step 408 of the difference in drafts, D1 (maximum draft)−D2 (current or calculated draft after “loading” of the grain products). At step 410, the type of grain (commodity) is then recorded in a lineup list (potentially suitable vessels) on the database if the commodity is present, or the step generates a threshold value for the draft based on the commodity parameters. Next, at step 412, the destination port classification for the specified commodity is checked to determine whether the port has been previously certified with respect to this grain commodity. If not (407), the draft difference D1−D2 versus “threshold” value is determined. If the threshold value is exceeded, the port is classified as a potential discharging port (416) or other port operation (418), subject to comparison to the port classification stored in the DB. If the threshold is not exceeded, the port is evaluated as a potential Loading (403) or Discharged operation (405), and depending on comparison to the most recent Port Classification, reclassified as either a “Loading Operation” (414) or a “Discharging Operation” (416), the latter confirmed by both the Port Classification determination as well as the draft difference D1−D2 exceeding the threshold, indicative of a fully-loaded vessel in port awaiting a discharging or other unloading operation which will clear cargo storage volume for a subsequent loading and shipment of grain. For vessels where the D1−D2 draft difference is less than the threshold and the classification has been confirmed as a loading operation, this process identifies a partially-loaded or unloaded (“dry”) vessel in port that is suitable for accepting a grain allotment for storage and subsequent shipment.

Proprietary information maintained by MARCURA includes information regards to the vessel's drafts. Various drafts are recorded in the database and the appropriate one is chosen in response to the location, season and sea-water density. Once an appropriate maximum draft is chosen, it is compared with the current draft. Based on the different types of vessels and their distinct characteristics like block-coefficient, DWT, LOA, and the like, distinct thresholds are calculated for different vessel types which have been marked suitable for carrying grain. The threshold is then considered as the basis for classification.

If the difference between the maximum and current draft is lesser than the threshold, the vessel may be classified as a vessel expected to perform a loading operation. However, an additional check must be performed in order to make the classification methodology robust and reliable. This additional check involves checking if a particular commodity is loaded or discharged at a particular port. This information for the check is derived from the vast number of transactions handled by DA-DESK. As such, an additional dimension, namely ‘Activity’, is added after due validation to the lineups DB.

To better illustrate, take for example the port at San Lorenzo, which is classified as one of the top grains-exporting ports in the database. Any vessel approaching San Lorenzo port with a draft value greater than the threshold can be easily classified as a vessel approaching for loading activity as it satisfies both checks. In contrast, a vessel approaching the port of Yantian with a draft value greater than the threshold can be classified as a vessel approaching for discharging activity as Yantian is classified as a port where discharging activity is carried out usually.

In certain cases, where partial loading occurs, this information is verified by means of local agents. These insights are extremely valuable as they help in improving overall reliability of the dataset. The embodiments of the present disclosure also consider information provided by agents as a deciding factor for classification and assignment. In some scenarios, if local information is not available, the assignment and classification is done in response to the Cargo at Berth (“C©B”) algorithm using MARCURA's historical data.

Extracting Previous Port

As discussed in previous operations, it is not sufficient to understand only one side of the entire transaction. It is of utmost importance to dive deeper and extract the origin or destination port of the vessel. This prediction is in response to multiple analytically predictive factors, and modelling of evolving trends and distinct patterns observed in the past and as recorded in the AIS and lineups DB.

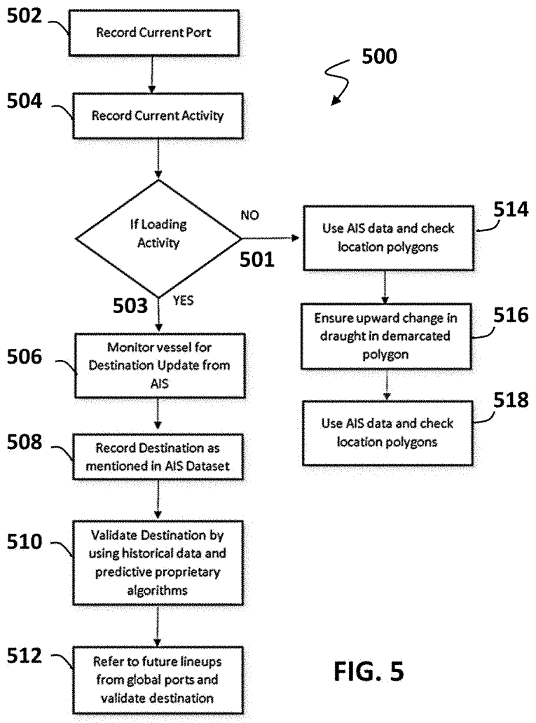

FIG. 5 illustrates steps in a method (500) that may be employed in certain embodiments to identify regions (“polygons”) and specific ports (“destinations”) within the spacial polygon regions that are suitable for either an uploading or discharge operation based on the vessel load status (loaded or unloaded with grain, to be uploaded and available for grain, etc.) and other vessel parameters. The process starts at step 502, accessing the appropriate databases to locate and then record the current port that the vessel is located at and the activity at that port is recorded (504). If it is determined that loading activities are presently underway (503), then the vessel is monitored (506) until its destination port has been inputted to the AIS database, which is then updated by recording the vessel destination in step 508. Next, the system determines whether the destination port is suitable by comparing to historical data in the AIS as well as predictive proprietary algorithms that are employed to calculate validation without a prior validation record being generated (510). Once a specific potential destination is found, the AIS is updated so that the system can refer to future lineups updated from global port parameters and then validate that destination port in step 512, its identity and activity now available in the database for selection and further evaluation.

If, however, no loading activity at that particular point is found (501), then AIS data is evaluated to determine a group of suitable ports within a spacial region or “polygon” in step 514. Vessels found in the AIS database that are within the polygon are then evaluated in step 516 to ensure that there is a suitable draft difference value (e.g., that vessel is partially unloaded or dry and accepting of a potential grain shipment), and this is repeated for every vessel found within the polygon to create a list of suitable vessels with acceptable draft differences indicative of being suitable for grain carriage in step 518.

Allocating IMOs to Vessel Names

MARCURA aggregates vessel lineups from various shipping agencies around the globe and thus it is highly impossible to have all these in a single standard format. Although, critical details like cargo and quantity are mentioned in most cases, some cases lack unique identifiers like IMO number, MMSI or CALLSIGN. Assigning these identifiers to the vessel names is of paramount importance as it is a necessary factor in further classification exercises. Assigning an IMO to a vessel name allows other distinguishing characteristics like DWT (deadweight), GT (gross tonnage), LOA (length overall), LBP (length between perpendiculars), NRT (net register tonnage), etc., to be available for further data manipulations. It is to be noted that although GRT (gross register tonnage), GT, NRT and NT (net tonnage) are referred to in tonnages, none of them measure weight. They are all terms that refer to a ship's internal volume, or its carrying capacity for a particular commodity. Flowing grains (like liquids) move to fill the entire available volume of a storage space, so that volume estimates for these types of commodities can be extremely accurate values in predicting carriage capability and volumes for grains and grain products. It is a very important step in understanding the commodity trading market as wrong vessel assignments can result in skewed decision making.

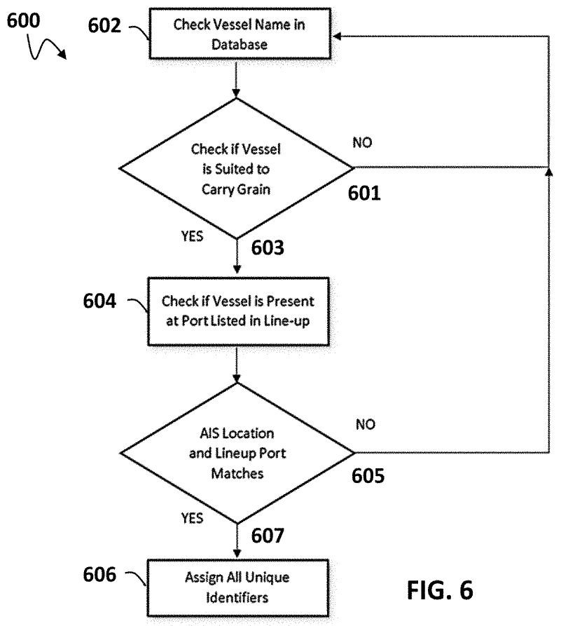

FIG. 6 illustrates steps in a method (600) that may be employed in certain embodiments to assign vessel identifiers indicative of validated vessels meeting the requirements for grain transportation. In FIG. 6, a first step 602 determines whether a particular vessel identified in an earlier operational step is present in the AIS database and particularly whether the vessel is suitable for carrying grain. If not suitable (601), the next vessel in the potential list is evaluated until at least one vessel is found suitable (603) for grain carriage. Next, it is determined at step 604 whether that vessel is present at the port listing in the lineup list. If not present in the Lineup (605), additional vessel names are searched to find another potential vessel from the list, which iteratively proceeds until a vessel is found suited both for carrying grain (603) and present at the port listed in the lineup (i.e., the AIS location and lineup port match) (607) at which point that particular vessel data is updated to reflect a suitable grain carriage vessel and unique vessel parameters are retrieved and used to update the database in a final step 606.

Terminal Allocation

In today's business environment where competitor intelligence is highly valued, decision-makers prefer if the information received is more detailed. Cargo flows data at the port level adds little value for the decision-makers. As such, the embodiments of the present disclosure add additional layers of information to include the terminal at which the activity was performed, and use this information according to the methods as disclosed to optimize the selection of a suitable grain carriage vessel either in real-time or via predictive methods which calculate the arrival of a suitable vessel at a validated port for either a loading or discharging operation. The more detailed evaluation of this information adds value for the decision-makers and makes them aware of all the risks they may be exposed to beforehand, such as berth availability, loading/unloading schedules and time limits, waiting times and such. Terminal-level cargo flows data helps the decision-makers to manage their activities more efficiently than ever before.

Allocating terminals to vessels is a critical part of this present method and analysis tool. In one embodiment of the present disclosure, allocation of terminals is achieved by either one or both of two methods, which are as follows:
(1) Extracting terminal from lineups, berthing schedules and berth booking documents; and/or
(2) Allocating terminal based on proprietary algorithm.

Extracting Terminal from Lineups, Berthing Schedules and Berth Booking Documents

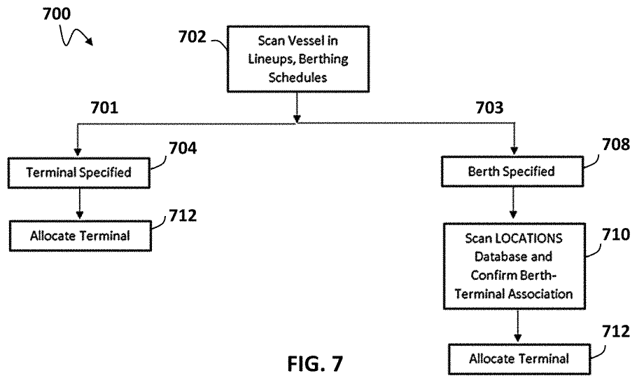

In some cases, lineups and berthing schedules include the terminal, berth or both at which the cargo operation will be performed. An example of such a lineup can be seen below. In cases where only a pier or berth is specified, an additional process is devised which extracts and allocates the terminal to the vessel. This association between a berth/pier and the terminal has already been established based on in-house research. This information is continuously updated. The research is conducted by referring to documents published routinely by the IMO and respective port authorities and by contacting port agents. The process is illustrated schematically in FIG. 7 below.

FIG. 7 illustrates steps in a method (700) that may be employed in certain embodiments to determine suitable terminals based on vessel identifiers indicative of validated vessels meeting the requirements for grain transportation, with available berthing and complementary schedules for access to the berth and access to the terminal. In FIG. 7, a first step 702 scans the lineups DB for a list of vessels that have potentially available berths and potentially complementary schedules for access. If a specific terminal (701) is identified, then the DB is updated with the specific terminal (704) and that terminal is then allocated (712) in the AIS database (712) as a suitable terminal, awaiting available berthing information. If a terminal is not associated with a particular vessel in lineups (703), but the berth is specified (708), then the application scans the location DB to confirm berth and terminal association in step 710 and then allocates that berth-associated terminal (712) in the AIS DB as a suitable terminal with specified berth information inputted for reference and confirmation of availability.

Allocating Terminal Based on Proprietary Algorithm

In cases where a berth or terminal cannot be extracted from the lineups or from the berthing schedules, the embodiments of the present disclosure resort to deploying a database process to extract information. Here, geographic functions provided in the database are used to accurately pinpoint the berth or terminal. In this case, it is not only useful but also necessary to segregate only the terminals which handle grain. This narrows down the search and allows only appropriate terminals to be extracted. Suitability of a terminal to be included in such a list depends on the past activity occurring at the said terminal. Here, data collected by DA-DESK over the years is heavily referenced.

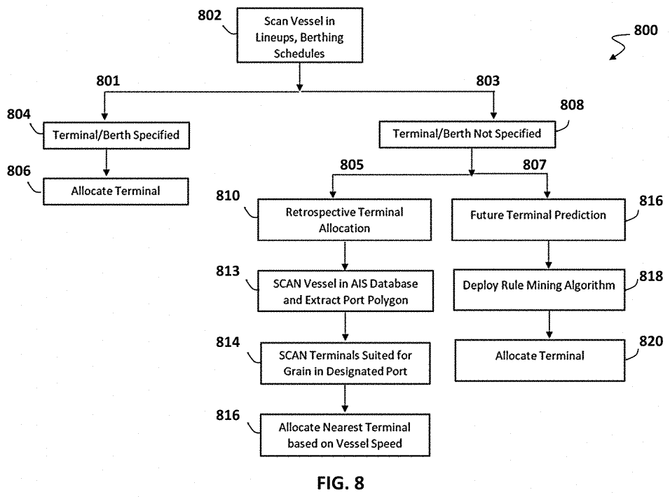

FIG. 8 illustrates steps in a method (800) that may be employed in certain embodiments to determine suitable terminals in response to vessel identifiers indicative of validated vessels based on the location of the vessel and, if in transit, its speed as relating to its estimated time of entry into a particular port or terminal. In FIG. 8, a first step involves scanning for the vessel name in the lineups DB and uploading berthing schedules to the application for evaluation if available (801). If available, the terminal and berth can be identified as a potential destination (804) and the system then allocates that terminal in step 806. However, if neither the terminal nor berth is specified (803) in the lineups DB, the next step in the application reviews vessel information (808) and then determines whether a past or retrospective terminal allocation has already been made (805) or a future terminal prediction is required (807) to be determined. If a retrospective terminal allocation (810) has been made, then the AIS DB is scanned in step 813 to extract port polygon information as to suitable terminals at a particular port or ports within the spacial polygon, and in a subsequent step 814 the suitable terminals are evaluated as to their suitability for grain carriage, and a designated port is found and assigned. Subsequently, the application then allocates (816) the nearest terminal within the polygon in response to the vessel speed, allocating the vessel whose speed would place it at the vicinity of the qualified terminal within a specified berthing time for a loading/unloading operation. However, if a future terminal prediction (816) needs to be made, the application deploys a rule mining algorithm that uses data in the AIS DB and lineups DB to predictively calculate a suitable terminal in response to an analysis of each suitable vessel's current location, heading and speed within the polygon and logged destination port to determine a suitable terminal, which would then be allocated in step 820, subject to confirmation of berthing information, such as availability and scheduling when the berthing schedules are updated to the AIS DB.

Association Rules Method for Generating Terminal-to-Terminal Flows

The methods and applications of the various embodiments of the present disclosure discussed herein are not only geared for information exploration, but also information aggregation. Further, the inventive embodiments also include methods by which missing data can be imputed. Imputing missing data becomes very important as the platform acts as a decision support system for various stakeholders in the shipping industry. Well-established imputation methods were explored, and results were validated against standard shipping logic.

Embodiments of the present disclosure also take into consideration multiple factors to impute the data and ensure that both quantitative and qualitative factors are included in the prediction methodology. Both quantitative and qualitative parameters are supported by shipping logic which validates the predictive methodology.

Association rule mining was chosen as the predictive methodology as it is very effective in recognizing patterns in repetitive occurrences. Shipping, by virtue of the supply-demand model, fits this repetitive occurrence and hence the association rule mining algorithm is useful in discovering patterns and predicting next moves by vessel operators. The use of these patterns can certainly be made in predicting missing data.

Other Operational Parameters

The parameters used in the association rule mining algorithms contribute to predicting the missing cargoes in a much better fashion than just applying standard shipping logic. The algorithm takes into consideration factors like type of the vessel, size of the vessel, port, terminal, berth, activity, operator, charterer and the vessel's past activity.

Type of the Vessel: MARCURA's vessel database is an all-encompassing database which includes details and particulars for more than 83,000 vessels. This database is updated on a regular basis to classify vessels as active or inactive. Also, changes to ownership, flag and port of registry are tracked routinely. As such, this updated vessel database forms a key component of the predictive algorithms. MARCURA has developed its own ‘VESSEL_TYPE’ classification methodology based on the vessel particulars listed in the database. Vessels are classified according to their cargo carrying capacity, design features and their involvement in cargo activities. The ‘VESSEL_TYPE’ gives key insights into the vessel's functionality and its use in general. In this case, bulk carriers are designed and suited to carry grains, whereas product tankers are more suited to vegetable oils and other byproducts from the grains industry.

Size of the Vessel:

Having classified the type, the size of the vessel (based on DWT) provides key insights into the vessel's suitability for the carriage of a particular cargo class. In this case, maritime logic generally allows vessels up to the Panamax class to carry grains. This consideration narrows down the search and helps in assigning appropriate cargoes.

Port, Terminal and Berth:

MARCURA has conducted extensive research with regards to cargo flows of grains and other agricultural commodities. This research was mostly based on the lineups received from agents and its own proprietary databases. Apart from that, information collected about ports since inception has paved the way for facilitating detailed know-how for almost all port location in the world. The spacial polygon model for ports and terminals has greatly helped in including entire ports in the algorithms or just using a small section by referring to terminal and berth data points. From its research, MARCURA could classify the ports based on the commodities they trade in and the activities they perform. For example, in majority of cases, the port of New Orleans in the United States is a port loading various grains. Here, the activity is classified as loading and the cargo is classified as grains.

Operator and Charterer:

The operator and charterer pairs provide valuable information about the cargo carried by the vessel. Based on the past activity of the vessel's operator and the cargoes carried by these agents in a particular terminal in a port, the cargo may be predicted.

The rule mining algorithm provides a robust method for predicting cargo as well as the terminals. Predictions with a very high lift (probability) or confidence level are finally selected so that missing data can be imputed. The present disclosure presents several embodiments of a method and application using available AIS and lineup data to optimize the determination and selection of suitable grain carriage vessels, berths, ports and terminals that are suitable for grain transport. The embodiments presented herein represent a robust application and predictive tool which supports vessel operators and other stakeholders in the shipping industry. This tool can be used for a wide range of purposes like information gathering, competitor intelligence and voyage optimization, etc.

Port Restrictions Database

A port restrictions database may contain information related to the operational capabilities of ports. These characteristics play a crucial role in ascertaining the vessel arrivals, vessel sizes and, by extension, the blend capabilities by taking into consideration parameters like load rate, crane capacities, operational timings, length of the berths, draft (depth) of the channel, etc.

Port restrictions databases are commercially available and may include fields like maximum arrival draft, maximum sailing draft, and maximum DWT acceptable. These types of fields aid the algorithm in ascertaining the size of the vessels that can be accommodated at certain berths as confirmed by port authorities. This information also provides details about the loading activity.

Cargo Quantity

Similar to other data collection, the cargo quantity may be ascertained using information from the lineups/fixtures and the agents. Some embodiments of the current disclosure may use vessel draft information to calculate TPCI, while others may use association rules or other predictive analytics. Once a cargo is determined, AIS information may be employed to verify the accuracy of the determination. For example, and without limitation, changes in vessel draft or movement may confirm cargo prediction.

The cargo quantity may play a crucial role in formulating operational strategies for shipping companies and, by extension, supply chain companies too. Information related to cargo quantity can be extracted from the reports, lineups and fixtures database with significant level of certainty. However, to fill up the gaps in the data, an algorithm was developed to estimate the quantity. Cargo quantity is a function of the vessel's draft. Taking advantage of this information and using other naval architecture parameters, such as block coefficient, waterplane area and the like, to estimate the quantity, the algorithm predicts the missing data points with increased accuracy. The algorithm may not wholly rely on the draft change patterns but may also take into consideration probabilities developed using advanced data models like rule mining, neural networks, etc. This consideration is important because using only a numeric approach tends to over-rely on the computation prowess of the algorithm. Considering qualitative attributes to supplement the quantitative ones provides great insights into the data. The combination is a more sophisticated way of filling up missing data as it optimizes both paradigms. The algorithm in FIG. 8 describes a way of assigning both ‘Cargo Operation’ and ‘Cargo Quantity’ to a particular transaction. First, the algorithm scans information provided by agents, brokers and information houses to extract the cargo operation and cargo quantity data and updates if found. If data is not available, the proprietary algorithms predict the cargo operation and cargo quantity based on the models described above.

After every shipment operation has been completed, any available analytical data collected from the ship, terminal, port and berth relating to the efficiency of the shipment operation is collected and used to update the database in order to improve the proprietary algorithm predictive capability for future events.

Client-Server Processing

FIG. 9 shows a functional block diagram of a client server system 900 that may be employed for some embodiments according to the current disclosure. In FIG. 9, a server 910 is coupled to one or more databases 912 and to a network 914. The network may include routers, hubs and other equipment to effectuate communications between all associated devices. A user accesses the server by a computer 916 communicably coupled to the network 914. The computer 916 includes a sound capture device such as a microphone (not shown). Alternatively, the user may access the server 910 through the network 914 by using a smart device such as a telephone or PDA 918. The smart device 918 may connect to the server 910 through an access point 920 coupled to the network 914. The mobile device 918 includes a sound capture device such as a microphone.

FIG. 9 includes a representative vessel 924 which operates to collect AIS information. The MS information is wirelessly coupled to a shore station 926, generally using conventional FM radio or satellite communications systems. The AIS information is transferred through the network 914 to a data storage system 912.

Conventionally, client-server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine-readable instructions to the server, which in turn executes them. Several forms of machine-readable instructions are conventionally known (e.g., applets) and are written in a variety of languages such as Java and JavaScript.

Client-server applications also provide for software-as-a-service (SaaS) applications where the server provides software to the client on an as-needed basis.

In addition to the transmission of instructions, client-server applications also include transmission of data between the client and server. Often, this entails data stored on the client to be transmitted to the server for processing. The resulting data is then transmitted back to the client for display or further processing.

One having skill in the art will recognize that client devices may be communicably coupled to a variety of other devices and systems, such that the client receives data directly and operates on that data before transmitting it to other devices or servers. Thus, data to the client device may come from input data from a user, from a memory on the device, from an external memory device coupled to the device, from a radio receiver coupled to the device, or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine, a data engine, an execution engine, a user interface (UI) engine, and the like may be employed. These engines may seek and gather information about events from remote data sources.

In this disclosure, the above described systems also include radio and satellite transmission systems as well as AIS information collection devices and the associated networks employed in the aforementioned AIS systems.

In addition, the information, including AIS messages, may be stored in a structured data store for sourcing the data when needed. This may include a series of discrete messages or data or may involve a larger aggregated message including information from multiple messages, including those messages appended as described herein. Accordingly, method steps that call for adding information, such as status, to a message, may be effectuated by adding a record to a structured data store associated with a particular ship or vessel or modifying an existing record to include additional information.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the embodiments presented herein.

1. A method for cargo volume analysis to optimize grain transport comprising:
(a) receiving Automatic Identification System (AIS) information at a network server, said network server coupled to a network and a database; wherein said AIS information includes at least a vessel draft information and a location information;
(b) calculating a Tonnes Per Centimeter Immersion (TPCI) value in response to the vessel draft information;
(c) determining the cargo type from the location information using predictive analytics;
(d) confirming the carriage capability for a grain or grain product using said predictive analytics;
(e) determining the cargo volume available for said grain or grain product from said predictive analytics; and
(f) updating said database by classifying identified vessels suitable for grain carriage.

2. The method of claim 1 wherein said predictive analytics includes applying association rules to an historical dataset to identify at least one or a plurality of vessels available for grain carriage having either a draught loading capacity or draught discharging capacity greater than or equal to the volume of said grain or grain product to be transported.

3. The method of claim 2 wherein said association rules include information about available shipping ports having terminals with grain handling capability and identifying at least one berth with the capacity for performing a shipment operation selected from a loading operation, discharging operation, another operation, or combination of said operations; wherein said berth meets at least one of said threshold draught loading capacity or draught discharging capacity.

4. The method of claim 3 wherein said predictive analytics includes using Lineup and Berthing Schedules to determine the most efficient combination of schedules for performing at least one or a plurality of said shipment operations between at least one ship and at least one suitable berth identified from said historical dataset; wherein said suitable berth has the capability and capacity of handling a shipment operation involving said grain or grain product.

5. The method of claim 4 wherein said predictive analytics determines the most efficient schedule for a specific vessel and port listed in said database and allocates a specific terminal and port to receive said vessel in response to the vessel speed and updates said database with a future terminal prediction to schedule said shipment operation.

6. The method of claim 5 wherein said predictive analytics includes using an artificial neural network in response to an historical dataset stored on said database.

7. A method for analyzing maritime cargo information comprising:
(a) receiving AIS information at a network server; said network server coupled to a network and a database; and wherein said MS information includes at least a vessel draft information and a location information;
(b) processing the AIS information to remove outliers, incomplete information, and to standardize the information format;
(c) effectuating association rules in response to said processing;
(d) applying said association rules in response to a query received at the network server; and
(e) responding to the query with the results; wherein said results include a list of ships with grain or grain product cargo space that lie within a projected spacial polygon of available ports with terminals having the capacity and capability of handling a shipment operation involving said grain or grain product.

8. The method of claim 7 wherein said association rules are determined in response to historic cargo information.

9. The method of claim 8 wherein said predictive analytics includes applying association rules to a historical dataset to identify at least one or a plurality of vessels available for grain carriage having a draught loading capacity or draught discharging capacity greater than or equal to the volume of grain or grain product to be transported.

10. The method of claim 9 wherein said association rules include information about available shipping ports having terminals with grain handling capability and having at least one berth with the capacity for performing a shipment operation selected from a loading operation, discharging operation, another operation, or combination of said operations; wherein said berth meets at least one of said threshold draught loading capacity or draught discharging capacity.

11. The method of claim 10 wherein said predictive analytics includes using Lineup and Berthing Schedules to determine the most efficient combination of schedules for performing at least one or a plurality of said shipment operations between at least one ship and at least one suitable berth identified from said historical dataset of available ships, ports, terminals and berths; wherein said suitable berth has the capability and capacity of handling a shipment operation involving said grain or grain product.

12. The method of claim 11 wherein said predictive analytics determines the most efficient schedule for a specific vessel and port listed in said database and allocates a specific terminal and port to receive said vessel in response to the vessel speed and updates said database with a future terminal prediction to schedule said shipment operation.

13. One or more processor-readable storage devices, said devices including non-transitory processor instructions directing a processor to perform a method comprising:
(a) receiving AIS information wherein said AIS information includes at least a vessel draft information and a location information;
(b) calculating a TPCI in response to the vessel draft information;
(c) determining cargo type from the location information using predictive analytics;
(d) confirming a grain or grain product using predictive analytics;
(e) determining the cargo volume available for said grain or grain product from said predictive analytics;
(f) confirming carriage capability for a grain or grain product using predictive analytics;
(g) determining the cargo volume available for said grain or grain product from said predictive analytics; and
(h) updating said network by classifying vessels suitable for grain carriage in said database.

14. The method of claim 13 wherein the association rules are determined in response to historic cargo information.

15. The method of claim 14 wherein the step of responding to the query includes a response with a grain or grain product information; wherein said grain or grain product information includes the type of said grain or grain product, volume or draft displacement of said grain, and the type of shipment operation.

16. The method of claim 15 wherein the association rules include information about the most frequent transactions and generates the most likely transactions; and wherein said response to said query identifies a port, a terminal and a berth location that will be available to perform said shipment operation.

17. The method of claim 16 wherein said predictive analytics determines the most efficient schedule for a specific vessel and port listed in said database and allocates a specific terminal and port to receive said vessel in response to the vessel speed and updates said database with a future terminal prediction to schedule said shipment operation.

18. The method of claim 17 wherein said historic cargo information is updated on said database to include said future terminal prediction and schedule information for the specific vessel and port allocated for said shipment operation.

19. The method of claim 18 wherein said database is updated after said shipment operation has been completed with at least one or a plurality of operations parameters associated with said shipment operation.

20. The method of claim 19 wherein said database is updated with vessel and destination information to enable determination and scheduling of a second shipment operation for said specific vessel at a second destination port, terminal and berth, for a subsequent shipment operation.
